(19) United States
(12) Patent Application Publication
(10) Pub. No.: US 2013/0326146 A1
(43) Pub. Date: Dec. 5, 2013

(54) INFORMATION PROCESSING APPARATUS, MEMORY APPARATUS, AND DATA MANAGEMENT METHOD

(71) Applicants: KABUSHIKI KAISHA TOSHIBA, Tokyo (JP); TOSHIBA SOLUTIONS CORPORATION, Tokyo (JP)

(72) Inventor: Tomonori ABE, Tokyo (JP)

(73) Assignees: TOSHIBA SOLUTIONS CORPORATION, Tokyo (JP); KABUSHIKI KAISHA TOSHIBA, Tokyo (JP)

(21) Appl. No.: 13/783,578

(22) Filed: Mar. 4, 2013

(30) Foreign Application Priority Data
May 30, 2012 (JP) 2012-123452

(51) Int. Cl. G06F 12/08

(52) U.S. Cl. CPC G06F 12/084
USPC 711/130

(57) ABSTRACT

An information processing apparatus that appropriately manages data of an auxiliary memory apparatus is provided to prevent data from leaking. The information processing apparatus includes a first memory apparatus, a second memory apparatus, and a caching unit. The caching unit stores write data to be written on the second memory apparatus in a cache area ensured on the first memory apparatus. When a first event occurs, the caching unit initializes a management information table, in which the address of the cache area in which the write data is stored is associated with the address of the second memory apparatus in which the write data is to be stored, and restores the second memory apparatus to a state pervious to a state in which data is written.

### CROSS REFERENCE TO RELATED APPLICATION

This application is based upon and claims the benefit of priority from the prior Japanese Patent Application No. 2012-123452, filed on May 30, 2012, the entire contents of which are incorporated herein by reference.

### FIELD

Embodiments of the present invention relate to a data management technology suitable for a hard disk drive (HDD), a universal serial bus (USB) memory, or the like applied to a personal computer (PC).

### BACKGROUND

In recent years, PCs have widely been spread for both business use and personal use. In PCs, various memory apparatuses such as RAMs, HDDs, or USB memories capable of writing/reading data are used. Various data management methods for such kinds of memory apparatuses have been suggested until now.

In corporations, n PCs are used by m (where n<m) staffs, so that the PCs can be shared.

When the PCs are shared, it is not desirable that data used by users remain in the PCs from a viewpoint of security or privacy protection. Further, it is not desirable that other users take out the data stored in the PC. Furthermore, it is not desirable to data relevant to a PC system state be changed by the users using the PC.

### BRIEF DESCRIPTION OF THE DRAWINGS

FIG. 1 is a diagram illustrating a system configuration of an information processing apparatus according to a first embodiment;

FIG. 2 is a diagram illustrating a hierarchical software group of the information processing apparatus according to the first embodiment;

FIG. 3A is a diagram illustrating a first example of a memory table used in the information processing apparatus according to the first embodiment;

FIG. 3B is a diagram illustrating a second example of a memory table used in the information processing apparatus according to the first embodiment;

FIG. 4A is a diagram illustrating a first example of a device table used in the information processing apparatus according to the first embodiment;

FIG. 4B is a diagram illustrating a second example of a device table used in the information processing apparatus according to the first embodiment;

FIG. 5 is a diagram illustrating a block state of a memory maintained by the information processing apparatus according to the first embodiment;

FIG. 6 is a diagram illustrating data of a cache operation mode maintained by the information processing apparatus according to the first embodiment;

FIG. 7 is a flowchart illustrating an operation order when the information processing apparatus according to the first embodiment is activated;

FIG. 8 is a flowchart illustrating an operation order when the information processing apparatus according to the first embodiment is shut down;

FIG. 9A is a flowchart illustrating an operation order when the information processing apparatus according to the first embodiment makes a read request (part1);

FIG. 9B is a flowchart illustrating an operation order when the information processing apparatus according to the first embodiment makes a read request (part2);

FIG. 10 is a flowchart illustrating an operation order when the information processing apparatus according to the first embodiment makes a write request;

FIG. 11 is a flowchart illustrating an operation order when the information processing apparatus according to the first embodiment makes a flash request;

FIG. 12 is a flowchart illustrating an operation order when Trigger 1 of the information processing apparatus according to the first embodiment is generated;

FIG. 13 is a flowchart illustrating an operation order when Eject of the information processing apparatus (an auxiliary memory apparatus) according to the first embodiment is ejected;

FIG. 14 is a flowchart illustrating an operation order when Trigger 2 of the information processing apparatus according to the first embodiment is generated;

FIG. 15 is a flowchart illustrating an operation order when Trigger 3 of the information processing apparatus according to the first embodiment is generated; and

FIG. 16 is a diagram illustrating a system configuration of a computer system to which a memory apparatus according to a second embodiment is applied.

### DETAILED DESCRIPTION

An information processing apparatus that appropriately manages data of an auxiliary memory apparatus is provided to prevent data from leaking. The information processing apparatus according to an embodiment includes a first memory apparatus, a second memory apparatus, and a caching unit. The caching unit stores write data to be written on the second memory apparatus in a cache area ensured on the first memory apparatus. When a first event occurs, the caching unit initializes a management information table, in which the address of the cache area in which the write data is stored is associated with the address of the second memory apparatus in which the write data is to be stored, and restores the second memory apparatus to a state pervious to a state in which data is written.

Hereinafter, embodiments will be described with reference to the drawings.

### First Embodiment

First, a first embodiment will be described.

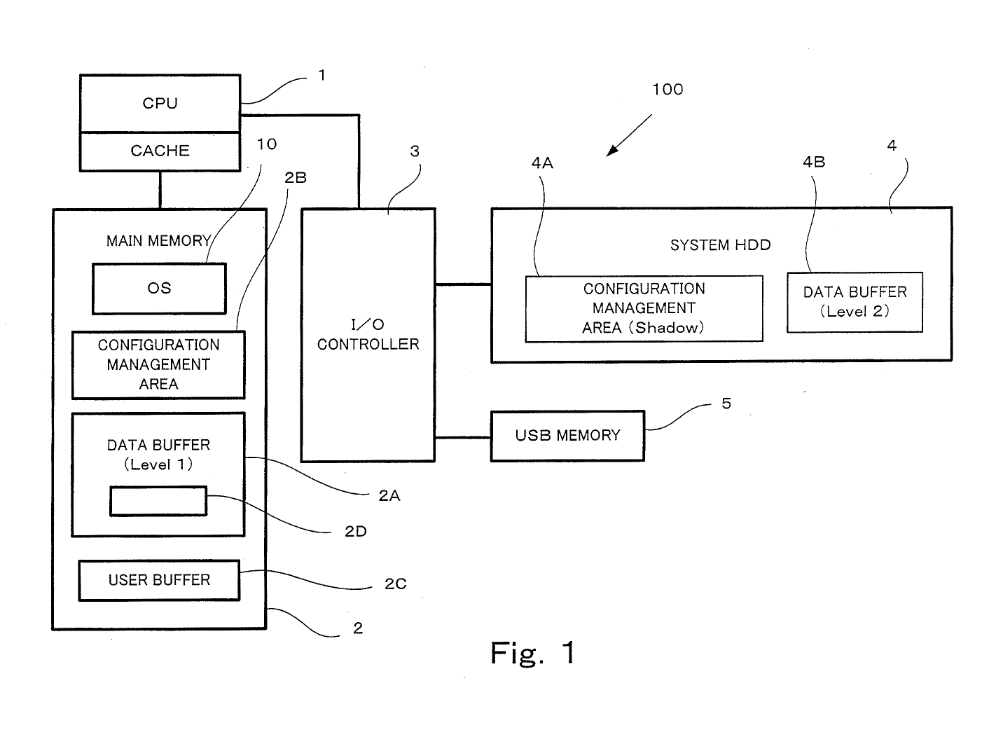

FIG. 1 is a diagram illustrating a system configuration of an information processing apparatus according to the first embodiment.

As illustrated in FIG. 1, an information processing apparatus 100 includes a central processing unit (CPU) 1, a main memory apparatus (hereinafter, referred to as a memory) 2, an I/O controller 3, an auxiliary memory apparatus (hereinafter, referred to as a system HDD) 4, and the like. Here, I/O devices such as a keyboard, a mouse, and a monitor generally connected to the I/O controller 3 are not illustrated. Further, a ROM or a flash memory storing firmware or the like having functions necessary for system activation is also not illustrated. These units are dependent on a system configuration, and thus the ROM or the flash memory is directly connected to the CPU 1 or is connected to the CPU 1 via the I/O controller 3. The I/O controller 3 includes a plurality of controllers such as a VGA controller, a SATA controller, and a USB controller.

Basic software such as an operating system (OS) 10 is stored in the system HDD 4. When the firmware is operated by the CPU 1 and an execution program or configuration information stored in the system HDD 4 is loaded on the memory 2, the system is activated only by the CPU 1 and the memory 2. Thereafter, an execution program loaded on the memory 2 reinitializes the I/O controller 3, the I/O devices connected to the I/O controller 3, and the auxiliary storage apparatus.

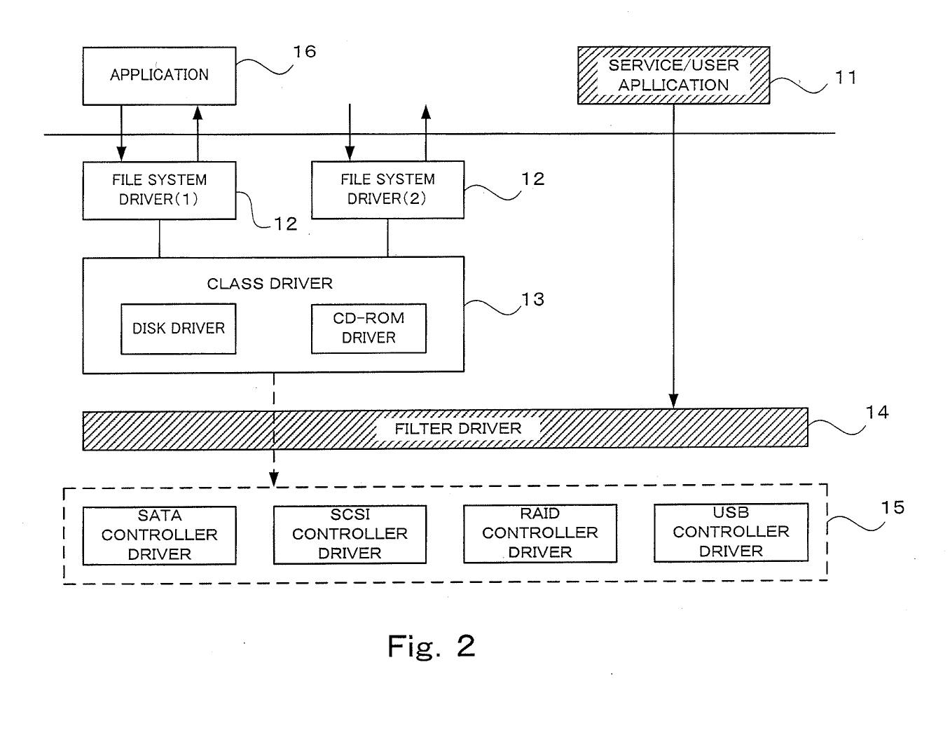

At this time, for example, as illustrated in FIG. 2, the hierarchical software group is sequentially initialized upwardly from the lowest layer. The reinitialization is executed by an execution program called a driver 15 including various control drivers which the OS 10 has. Various I/O devices (for example, an HDD and a CD-ROM) connected to the I/O controller 3 are initialized by a disk driver and a CD-ROM driver called a class driver 13. After the reinitialization, the class driver 13 and the driver 15 execute various requests by controlling each controller (an SATA, an SCSI, an RAID, and a USB) and various devices. An auxiliary memory apparatus such as the system HDD 4 or the USB memory 5 is generally initialized by a file system such as an FAT32 or a UDF. The file system driver 12 manages data stored in the system HDD 4 or the USB memory 5. When the file system driver 12 is initialized and a core service portion of the OS 10 is initialized/activated completely, the system can be generally said to be activated.

Various applications 16 can operate data using the corresponding file system driver 12 without considering the physical configuration or characteristics of the system HDD 4 or the USB memory 5 or a controller of the I/O controller 3.

In the information processing apparatus illustrated in FIG. 1, there is a considerable difference in a speed between registers or arithmetic units in the system HDD 4, the memory 2, and the CPU 1, and thus the speed of the memory apparatus operating slowest may be reduced to a response speed of the system as it is. In order to avoid this problem, a technology called cache is hierarchized and mounted in various places. For example, in FIG. 1, a cache memory is configured between the CPU 1 and the memory 2. Examples of the cache system include a direct map mode, a complete association mode, and an n-Way Set associative mode. Further, the cache system is classified into a read cache and a write cache. Examples of the cache management methods include an LRU, an MRU, an LFU, and the like.

In the read cache, a program code and data frequently used are stored in a memory apparatus (cache memory) with a faster access speed and are read at high speed. Thus, the frequency of access to a memory apparatus with a slow access speed can be lowered. On the other hand, in the write cache, writing is assumed to be completed only when data to be written is once stored in a memory apparatus (cache memory) with an access speed faster than that of a final-stage memory apparatus. When a program being executed continues to operate, and then the data stored in the memory apparatus with the fast access speed is collectively written to the final-stage memory apparatus, a response speed is superficially improved.

In FIG. 1, the cache memory is provided between the CPU 1 and the memory 2, but a part of the memory 2 (for example, a data buffer 2A) is generally used as the cache memory for the system HDD 4. Further, a cache memory is generally mounted inside the system HDD 4. There are various cache mounting forms in addition to the above-described forms, but the details of the cache mounting forms will not be described here.

The USB memory 5 configured by a NAND flash memory or the like in FIG. 1 has characteristics in which reading is executed at high speed but writing is executed at low speed. It is very effective to use a write cache for the USB memory 5. Due to the compliance to recent corporate governance, control of permission to write information to a device such as the USB memory 5 easily removable from the information processing apparatus is required. Further, an SATA, an SCSI, an RAID, or the like can be set as a removable device, but the USB memory 5 will be described below as an example. A connection interface is not limited to a USB, but an interface such as a SAS, an SATA, an IEEE 1394, a Thunderbolt may be used.

When a computer is shared using thin-client terminals or the like by a plurality of users, it is not desirable that information written by an immediately previous user remain in the system HDD 4 from a viewpoint of information security. To avoid this problem, a technology for reliably removing information written by the immediately previous user is required.

The information processing apparatus 100 has a configuration suitable for these requests. Hereinafter, the configuration will be described in detail.

First, an overview of a realization method will be described. A normal write cache executes a flash process after giving a notification of completion of the write request. For example, the normal write cache detects an idle state of the CPU 1, the memory 2, the system HDD 4, or the USB memory 5 and writes the data overwritten on the cache memory onto the system HDD 4 or the like at a timing at which load does not interfere with execution of another program. This write operation is a flash process.

On the other hand, the information processing apparatus 100 according to the embodiment once stores all of the data written on each device (for example, the system HDD 4) in the write cache memory. When the writing is permitted, the flash process is executed for the first time. The data may not be written to the device as long as the writing is not permitted. The permission mentioned here is authentication to a server or a user's operation, but the permission is not determined as the authentication or the user's operation. Thus, by storing data to be written once in the write cache memory, the data can be also read.

### (System Configuration)

In the information processing apparatus 100, dedicated Level 1 Buffer (data buffer) 2A and a configuration management area 2B are ensured inside the memory 2. The configuration management area 2B is an area in which configuration management information is stored. Here, the USB memory 5 is a speed-up target memory at the time of a cache operation. The system HDD 4 is an auxiliary memory apparatus that operates, for example, at the time of system activation. When the system HDD 4 is used as the cache memory, a Level 2 Buffer 4B (data buffer) and a configuration management area (Shadow) 4A as a replication of the configuration management area 2B are ensured in the system HDD 4. When a sufficiently large capacity can be ensured as a Level 1 Buffer 2A on the memory 2, such a configuration in which the configuration management area (Shadow) 4A or the Level 2 Buffer 4B illustrated in FIG. 1 is not used is possible.

In practice, however, a sufficiently large area of the Level 1 Buffer 2A may not be ensured, since the capacity of the memory 2 is limited. Therefore, when data to be written on the USB memory 5 is assumed to be greater than the capacity of the Level 1 Buffer 2A, the Level 2 Buffer 4B inside the system HDD 4 is allocated to take countermeasures against the shortage of the capacity of the Level 1 Buffer 2A. In the configuration of this case, the configuration management area (Shadow) 4A is not used. In terms of information security, the system HDD 4 to which the Level 2 Buffer 4B is allocated is required not to be easily removed, but it is not essentially required.

### (Code Configuration)

In the information processing apparatus 100 illustrated in FIG. 1, all of the requests to the USB memory 5 and the system HDD 4 as an auxiliary memory apparatus are required to be monitored. Therefore, a filter driver 14 is configured to be provided at a position between the driver and the class driver 13 illustrated in FIG. 2. The filter driver 14 realizes the cache function of the OS executed by the CPU 1. The filter driver 14 monitors all of the requests issued by the class driver 13. A service/user application 11 that controls the filter driver 14 is installed in the information processing apparatus 100. The service/user application 11 executes a query to a user interface or a server. The filter driver 14 executes the operation of monitoring the requests issued by the class driver 13 and the cache operation.

### (Data Structure)

In this embodiment, the cache operation is executed by the filter driver 14. An example of a data structure necessary for the filter driver 14 to execute the cache operation will be described.

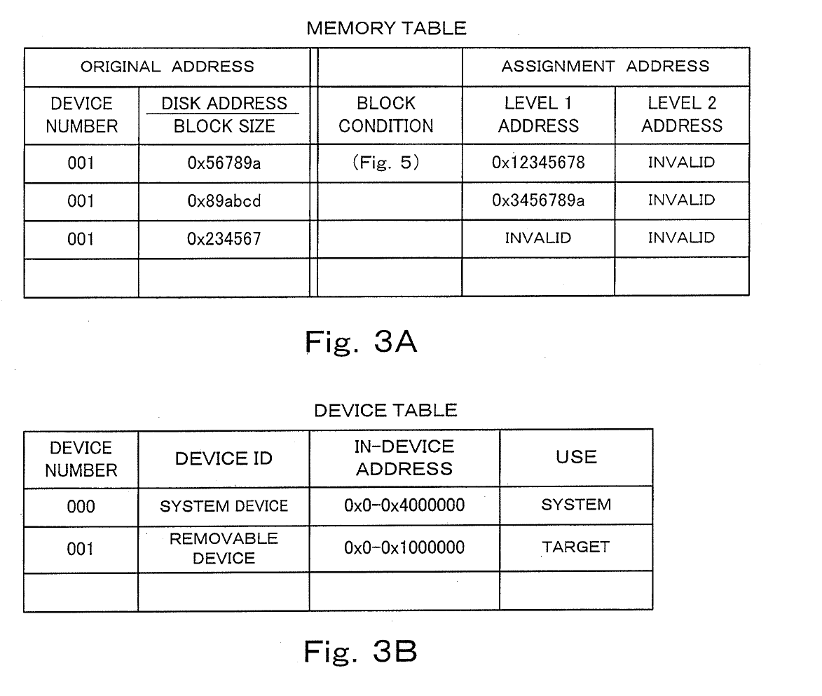

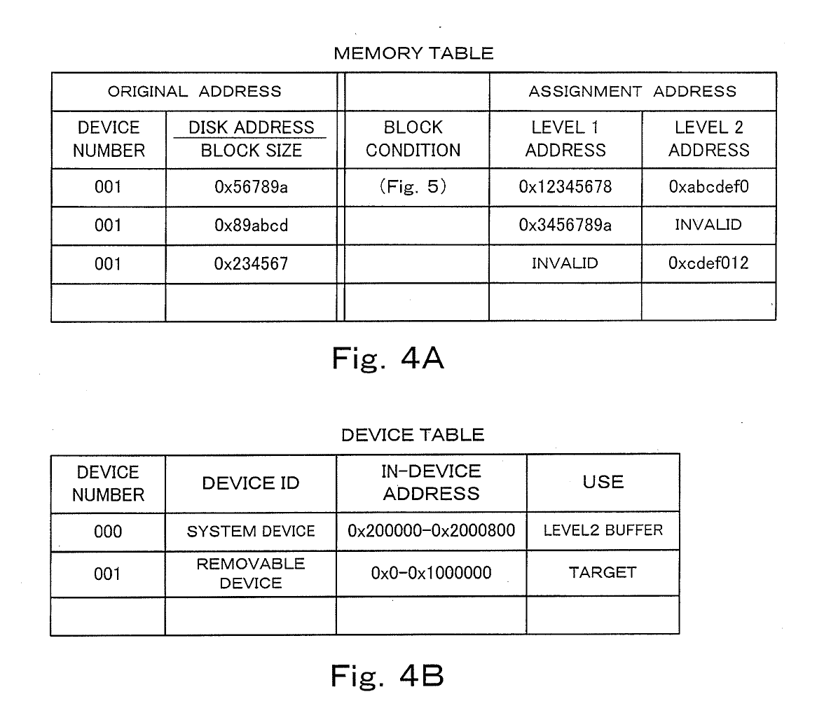

FIGS. 3A, 3B, 4A, and 4B are diagrams illustrating examples of memory tables and device tables stored in the configuration management area 2B at the time of the cache operation. FIGS. 3A and 3B illustrate the examples of the data structures when the cache operation is executed using only the Level 1 Buffer 2A as the cache memory. FIGS. 4A and 4B illustrate the examples of the data structures when the cache operation is executed using the Level 1 Buffer 2A and the Level 2 Buffer 4B as the cache memory.

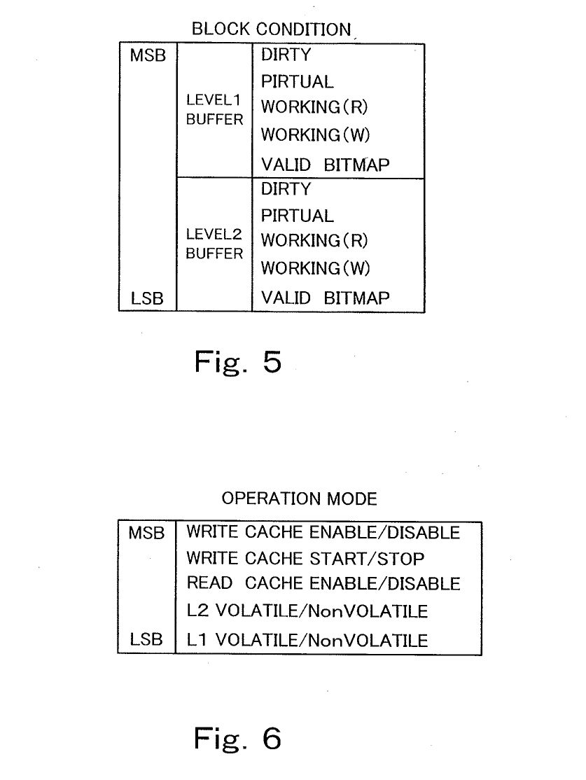

In FIG. 3A, the memory table is illustrated when the cache memory of a complete associative mode is used as an example. In the form of the memory table in FIG. 3A, the number of rows (hereinafter, the row is referred to as an entry) increase by the capacity of the Level 1 Buffer 2A and the size (=block size) of a block which is a management unit. Further, in the form of the memory table in FIG. 4A, the capacity of the Level 2 Buffer 4B is also taken into consideration. In columns in a block state of the memory table, data indicating the block state illustrated in FIG. 5 is stored. Data indicating an operation mode of the cache memory is illustrated in FIG. 6. The data indicating the operation mode can correspond to the memory table and is stored in the configuration management area 2B.

In the columns of “original addresses” of the memory tables illustrated in FIGS. 3A and 4A, the columns of a “device number” and a “Disk address/block size” are provided. In the column of the “device number,” a cache target device, that is, a speed-up target device is indicated by a device number recorded in the device table illustrated in FIG. 3B or 4B. In the column of the “Disk address/block size,” an address obtained through calculation of “Disk address” “block size” is indicated. This address indicates the address of a block which is a management unit in the cache target device. In the columns of “assignment addresses” of the memory tables illustrated in FIGS. 3A and 4A, a “Level 1 address” and a “Level 2 address” are provided. In the “Level 1 address” the address of the corresponding block is recorded when the block of the Level 1 Buffer 2A is allocated as the cache memory. In the “Level 2 address” the address of the block is recorded when the block of the Level 2 Buffer 4B is allocated as the cache memory. When the Level 1 Buffer 2A or the Level 2 Buffer 4B may not be allocated as the cache memory, “Invalid” is recorded in the column of “Level 1 address” or the column of “Level 2 address”. In the column of the block state, data indicating the block state illustrated in FIG. 5 is stored. The block state indicates the data indicating the block state of the Level 1 Buffer 2A or the Level 2 Buffer 4B assignable as the cache memory.

The uppermost entry in the memory table illustrated in FIG. 3A will be described as an example. A block indicated by the original address “0x56789a” indicated by the device number “001” in the USB memory 5 is a cache target block. In regard to the cache target block, a block indicated by the address “0x12345678” of the Level 1 Buffer 2A can be assigned as the cache memory. The Level 2 Buffer 4B is not assigned as the cache memory. Therefore, “Invalid” is set in the column of the “Level 2 address”. When the block assigned as the cache memory is used as a read cache, all of the bits of “Valid Bitmap” in the “block state” are set to be valid. That is, the bits of “Valid Bitmap” corresponding to all of the addresses of the blocks are set to be valid. On the other hand, when the block allocated as the cache memory is used as a write cache, “Dirty” is set in the address on which the data is written.

In the device tables illustrated in FIGS. 3B and 4B, the “device number”, a “device identifier”, an “in-device address” which is a speed-up target, and a “use” that indicates for what the speed-up target address is used are set. As the “device identifier,” an identifier unique for each device is used. Here, a simple identifier is exemplified.

The uppermost entry in the device table illustrated in FIG. 3B, the device number “000” indicates a system device (here, the system HDD 4) and the in-device addresses “0x0-0x4000000” are the addresses of speed-up targets by a cache. Further, the second entry from the upper side of the device table, the device number “001” is a removable device (here, the USB memory 5) and the in-device addresses “0x0-0x1000000” are the addresses of speed-up targets by a cache. In FIG. 3B, the removable device is set as the speed-up target device (Target).

On the other hand, in the uppermost entry in the device table illustrated in FIG. 4B, the device number “000” is a system device (here, the system HDD 4) and the in-device addresses “0x200000-0x2000800” are allocated to the Level 2 Buffer 4B. At this time, other addresses in the same device are not the speed-up targets by a cache. The device number “001” is the same as the device table illustrated in FIG. 3B.

As an example (not illustrated), the use or the in-device address can remain as a blank. The blank indicates an address is neither a speed-up target by a cache nor a device in which Level 2 Buffer 4B is ensured. In FIG. 4B, the example in which the Level 2 Buffer 4B is ensured in the system device (the system HDD 4) has been given, but another device may be connected and used. In this case, the in-device address of the system device is set as in FIG. 3B to be set as a speed-up target.

Further, when the Level 2 Buffer 4B is used, rewriting from other than the filter driver 14 is required to be prohibited. Therefore, a request issued from the class driver 13 is monitored and a request to rewrite data on the Level 2 Buffer 4B is aborted.

### (Construction/Activation Order)

In this embodiment, as the configuration management information, the data indicating the operation mode and the device table are stored as initialization options of the driver 15 in the system device (here, the system HDD 4). When the driver 15 receives such option information at the time of activation, the respective tables illustrated in FIGS. 3A, 4A, 3B, and 4B are constructed in the configuration management area 2B of the memory 2. In this embodiment, since the configuration management area (Shadow) 4A is not ensured, a learning state (=the memory table) at the time of the previous activation starts to be operated from the initialized state. That is, in this embodiment, Level 2 Volatile of the data indicating the operation mode is Yes.

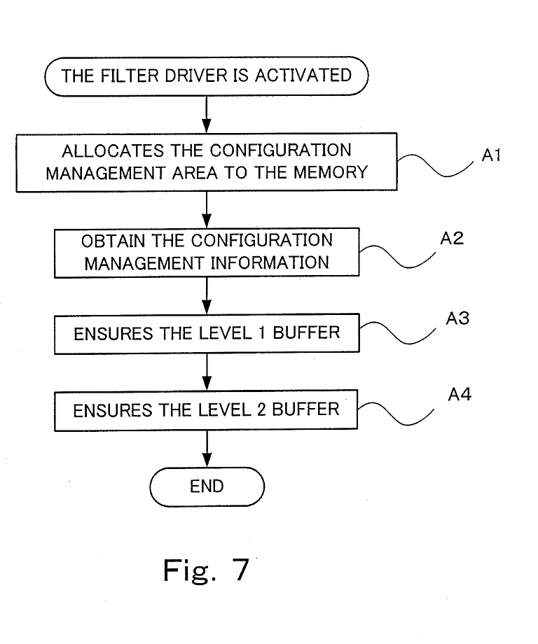

FIG. 7 is a flowchart illustrating an operation order when the information processing apparatus 100 is being activated.

When the filter driver 14 is activated, the filter driver 14 allocates the configuration management area 2B to the memory 2 to store the configuration management information (block A1). When the configuration management area (Shadow) 4A is ensured, the filter driver 14 refers to the configuration management area 4A to obtain additional configuration management information, referring to the initialization options (block A2). In this embodiment, the configuration management area (Shadow) 4A is not ensured.

The filter driver 14 ensures the Level 1 Buffer 2A in the memory 2, referring to the initialization options (block A3). The filter driver 14 ensures the Level 2 Buffer 4B in the system HDD 4, referring to the initialization options or the configuration management information of the configuration management area 2B (block A4). Based on such information, the filter driver 14 determines the memory tables, the device table, data of the operation mode, and the like and starts the cache operation.

### (Shutdown Order)

In this embodiment, the learning state (=the memory table) does not need to be stored, since the configuration management area (Shadow) 4A is not ensured in the system HDD 4.

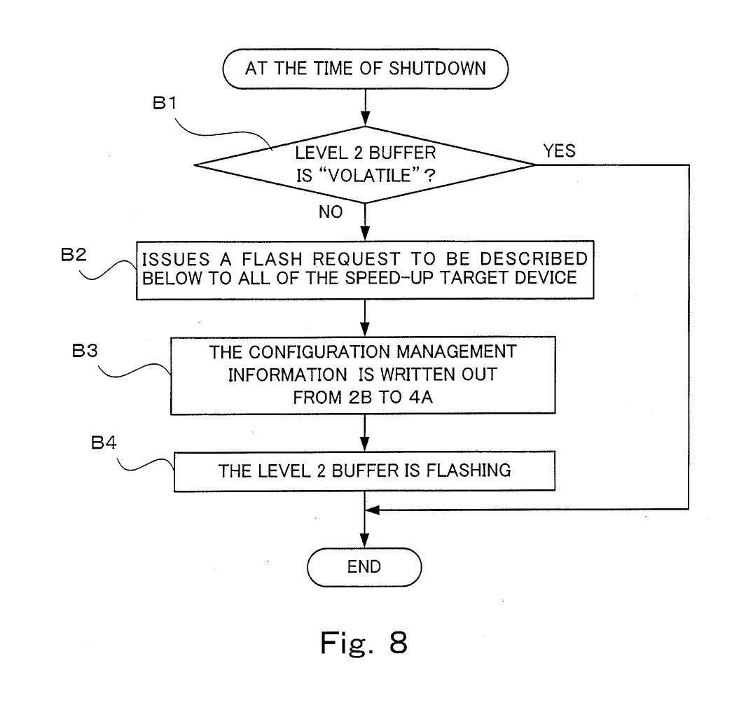

FIG. 8 is a flowchart illustrating an operation order at the time of shutting down the information processing apparatus 100.

When the service/user application 11 notifies the filter driver 14 of the shutdown, the filter driver 14 confirms whether the level 2 buffer 4B is volatile from the operation mode of the configuration management area 2B (block B1). For example, when the configuration management area (Shadow) 4A is not ensured in the system HDD 4 or when the Level 2 Buffer 4B is set to be initialized at each time of activating the system, “Yes” is set in Level 2 Volatile of the data of the operation mode. In this case, when the shutdown is notified of, the filter driver 14 does not execute any operation.

Conversely, when the configuration management area (Shadow) 4A is ensured in the system HDD 4, “No” is set in Level 2 Volatile of the data of the operation mode. In this case, the filter driver 14 issues a flash request to be described below to all of the speed-up target devices and waits for the completion of the operation (block B2). When the filter driver 14 completes the flash request, the filter driver 14 writes the contents of the configuration management area 2B on the configuration management area (Shadow) 4A (block B3). Then, the filter driver 14 requests the system HDD 4 having the configuration management area (Shadow) 4A and the Level 2 Buffer 4B to execute the original flash process (block B4).

### (Process at Each Request)

### (Read Request)

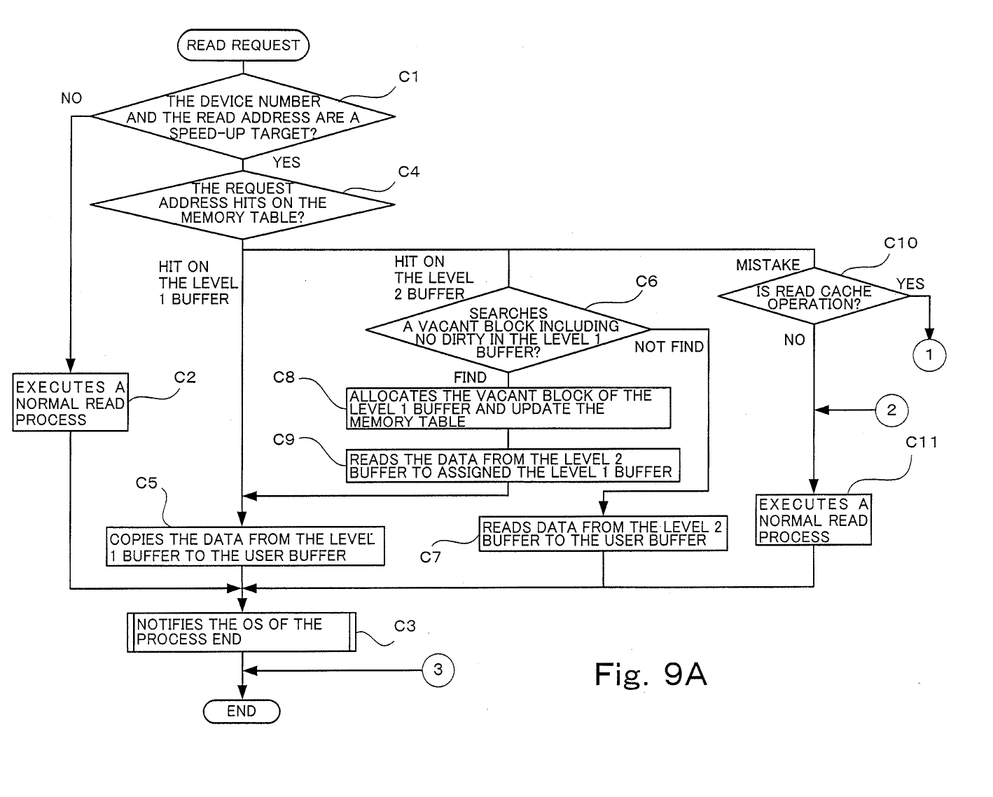

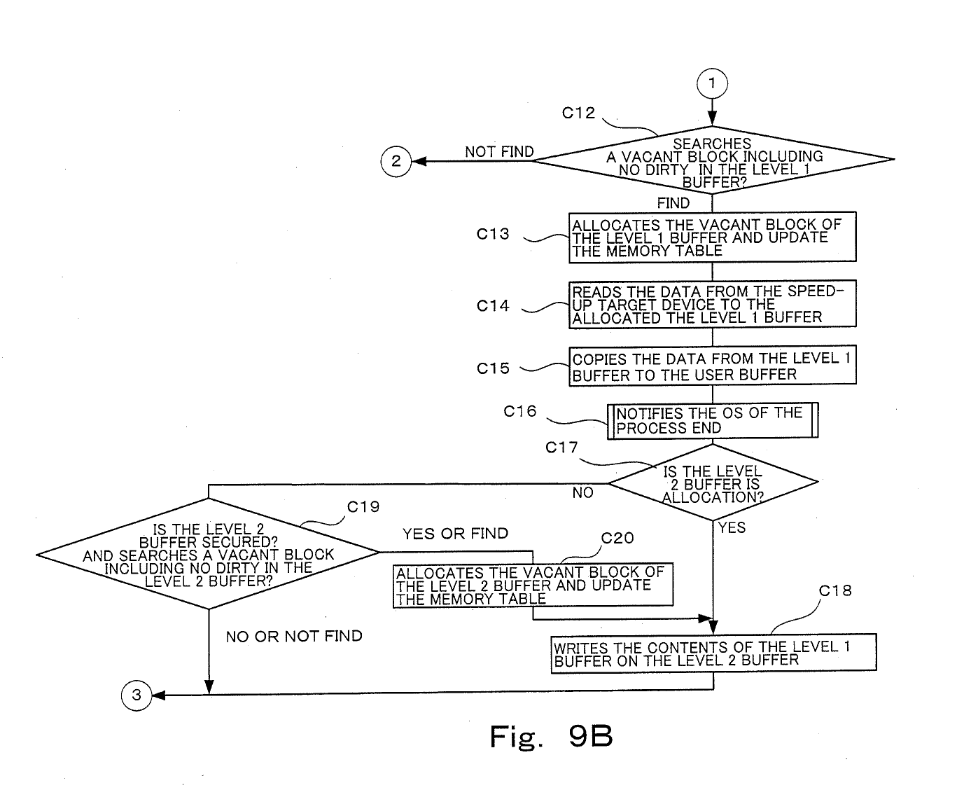

FIG. 9 is a flowchart illustrating an operation order when the information processing apparatus 100 makes a read request.

When the filter driver 14 receives the read request from the application 16, the filter driver 14 determines whether the device number and the read address of the received read request are the number and the address of a speed-up target (block C1). When the device number and the read address of the received read request are not the number and the address of a speed-up target, the filter driver 14 executes a normal read process (block C2) and notifies the OS 10 of the process end (block C3). When the device number and the read address of the received read request are the number and the address of a speed-up target, the filter driver 14 retrieves whether the read address of the request is cached from the memory table and executes cache determination of hit on the Level 1 Buffer 2A, hit on the Level 2 Buffer 4B, or mistake in which no hit on both Level 1 Buffer 2A and the Level 2 Buffer 4B (block C4).

When the hit on the Level 1 Buffer 2A is achieved, the filter driver 14 copies the hit on data from hit on the Level 1 Buffer 2A to a user Buffer 2C (block C5) and notifies the OS 10 of the process end (block C3). The user Buffer 2C refers to a work area of the memory 2 indicated by a copy point included in the read request and the write request.

When the hit on the Level 2 Buffer 4B is achieved, the filter driver 14 searches a vacant block including no Dirty in the Level 1 Buffer 2A (block C6). When the filter driver 14 does not find a vacant block, the filter driver 14 reads data from the Level 2 Buffer 4B to the user Buffer 2C (block C7) and notifies the OS 10 of the process end (block C3). Conversely, when the filter driver 14 finds the vacant block, the filter driver 14 allocates the vacant block of the Level Buffer 2A as the device and the address of the read request and accordingly updates the memory table (block C8). The filter driver 14 reads the data from the Level 2 Buffer 4B to the assigned the Level 1 Buffer 2A (block C9). Further, the filter driver 14 copies the data from the Level 1 Buffer 2A to the user Buffer 2C (block C5) and notifies the OS 10 of the process end (block C3).

When the mistakes in both the Level 1 Buffer 2A and the Level 2 Buffer 4B occur, the filter driver 14 determines whether a read cache operation is executed, by referring to the data of the operation mode (block C10). When the read cache operation is not executed, the filter driver 14 executes a normal read process (block C11) and notifies the OS 10 of the process end (block C3).

Even when the read cache operation is executed, the filter driver 14 searches a vacant block including no Dirty in the Level 1 Buffer 2A (block C12 in FIG. 9). When the filter driver 14 does not find a vacant block, the filter driver 14 executes the normal read operation (block C11) and notifies the OS 10 of the process end (block C3).

When the filter driver 14 finds the vacant block including no Dirty in block C12, the filter driver 14 allocates the device and the address of the vacant block of the Level 1 Buffer 2A as the device and the address of the read request and accordingly updates the memory table (block C13). Then, the filter driver 14 reads the data read from the speed-up target device (here, the USB memory 4) to the allocated the Level 1 Buffer 2A (block C14). Further, the filter driver 14 copies the data from the Level 1 Buffer 2A to the user Buffer 2C (block C15) and notifies the OS 10 of the process end (block C16).

Next, the filter driver 14 determines whether the allocation of the Level 2 Buffer 4B is completed for the address of the read request (block C17). When the allocation is completed, the filter driver 14 writes the contents of the Level 1 Buffer 2A on the Level 2 Buffer 4B (block C18) and ends the process. When the Level 2 Buffer 4B is not assigned in block C17, the filter driver 14 determines whether the non-allocation of the Level 2 Buffer 4B corresponds to a case in which the Level 2 Buffer 4B is not ensured or a case in which the Level 2 Buffer 4B including no Dirty is searched but not found (block C19). When the Level 2 Buffer 4B is not ensured or when the filter driver 14 does not find the Level 2 Buffer 4B including no Dirty, the filter driver 14 directly ends the process. Conversely, when the Level 2 Buffer 4B is ensured and when the filter driver 14 finds the Level 2 Buffer 4B including no Dirty, the filter driver 14 allocates the Level 2 Buffer 4B to the address of the read request and accordingly updates the memory table (block C20). Then, the filter driver 14 writes the contents of the Level 1 Buffer 2A on the Level 2 Buffer 4B (block C18) and ends the process.

### (Write Request)

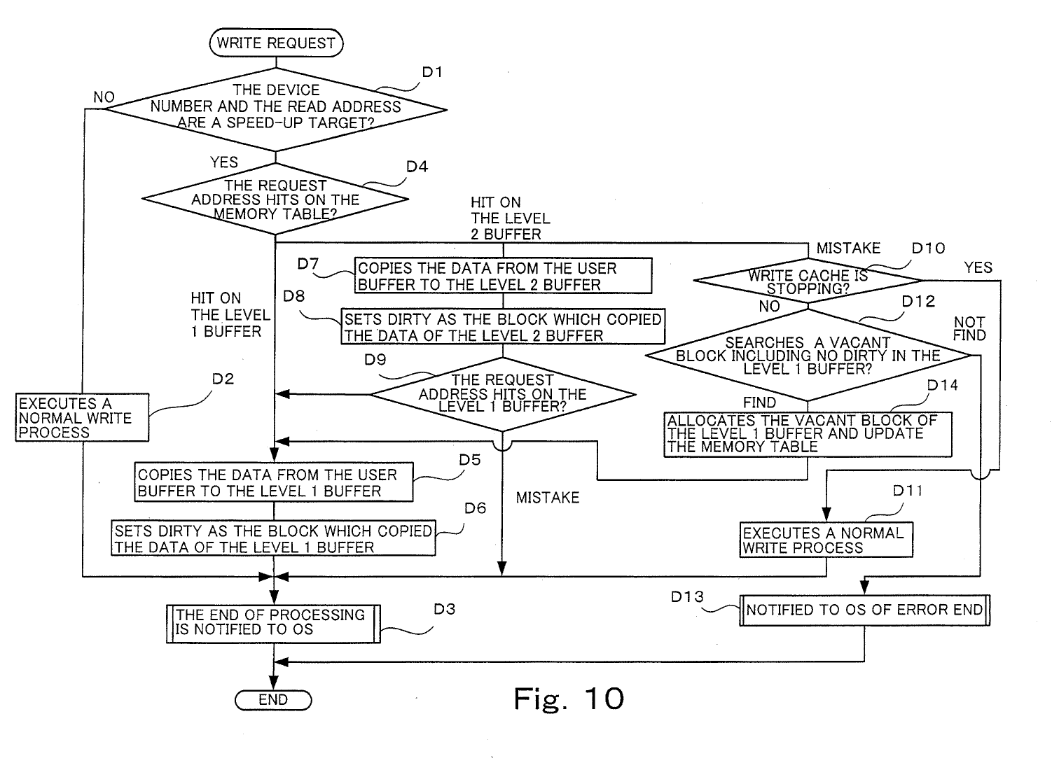

FIG. 10 is a flowchart illustrating an operation order when the information processing apparatus 100 makes a write request.

When the filter driver 14 receives a write request from the application 16, the filter driver 14 determines whether the device number and the write address of the received write request are a device number and a write address of the speed-up target (block D1). When the device number and the write address of the received write request are not the device number and the write address of the speed-up target, the filter driver 14 executes a normal write process (block D2) and notifies the OS 10 of the process end (block D3). When the device number and the write address of the received write request are the device number and the write address of the speed-up target, the filter driver 14 searches whether the write address of the request is cached from the memory table and executes cache determination of hit on the Level 1 Buffer 2A, hit on the Level 2 Buffer 4B, or mistake in which no hit on both Level 1 Buffer 2A and the Level 2 Buffer 4B (block D4).

In a case of the hit on the Level 1 Buffer 2A and the mistake in the Level 2 Buffer 4B, the filter driver 14 copies data stored in the user Buffer 2C and desired to be written to the already allocated the Level 1 Buffer 2A (block D5). Then, the filter driver 14 sets Dirty as the block which copied the data of the Level 1 Buffer 2A (block D6) and notifies the OS 10 of the process end (block D3).

In a case of the hit on the Level 2 Buffer 4B, the filter driver 14 copies data stored in the user Buffer 2C and desired to be written to the Level 2 Buffer 4B (block D7) and sets Dirty as the block which copied the data of the Level 2 Buffer 4B (block D8). Next, the filter driver 14 determines whether the Level 1 Buffer 2A is also hit (block D9). When the hit on the Level 1 Buffer 2A, the filter driver 14 copies data stored in the user Buffer 2C and desired to be written to the already allocated the Level 1 Buffer 2A (block D5). The filter driver 14 sets Dirty in the block of the Level 1 Buffer 2A on which the data is copied (block D6) and notifies the OS 10 of the process end (block D3). When the mistake in the Level 1 Buffer 2A occurs in block D9, the filter driver 14 notifies the OS 10 of the process end (block D3).

When the mistake in both the Level 1 Buffer 2A and the Level 2 Buffer 4B occurs, the filter driver 14 checks whether a write cache operation is stopping (block D10). When the write cache operation is being stopped, the filter driver 14 executes a normal write process (block D11) and notifies the OS 10 of the process end (block D3).

When the filter driver 14 determines that the write cache operation is being executed in block D10, the filter driver 14 searches a vacant block including no Dirty of the Level 1 Buffer 2A (block D12). When the filter driver 14 does not find the vacant block, the filter driver 14 notifies the OS 10 of error end (block D13). When the filter driver 14 finds the vacant block in block D12, the filter driver 14 allocates the vacant block of the Level 1 Buffer 2A to the address of the write request and accordingly updates the memory table (block D14). The filter driver 14 copies the data stored in user Buffer 2C and desired to be written to the allocated vacant block of the Level 1 Buffer 2A (block D5). Then, the filter driver 14 sets Dirty in the block of the Level 1 Buffer 2A on which the data is copied (block D6) and notifies the OS 10 of the process end (block D3).

### (Flash Request)

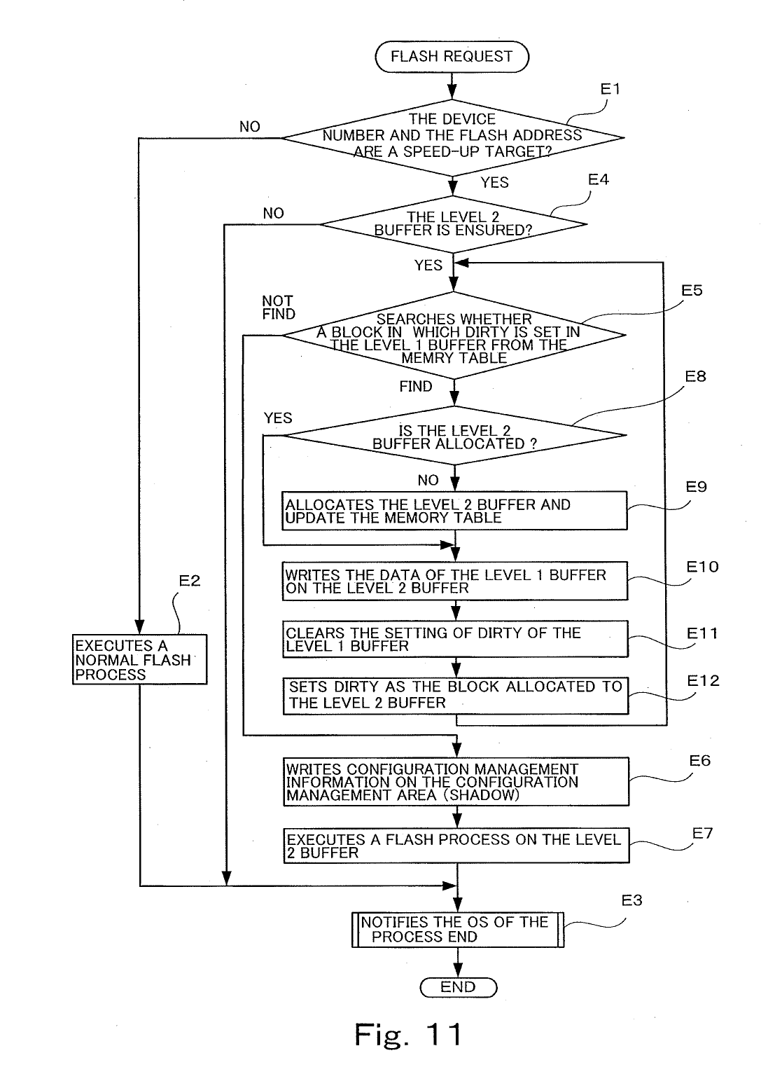

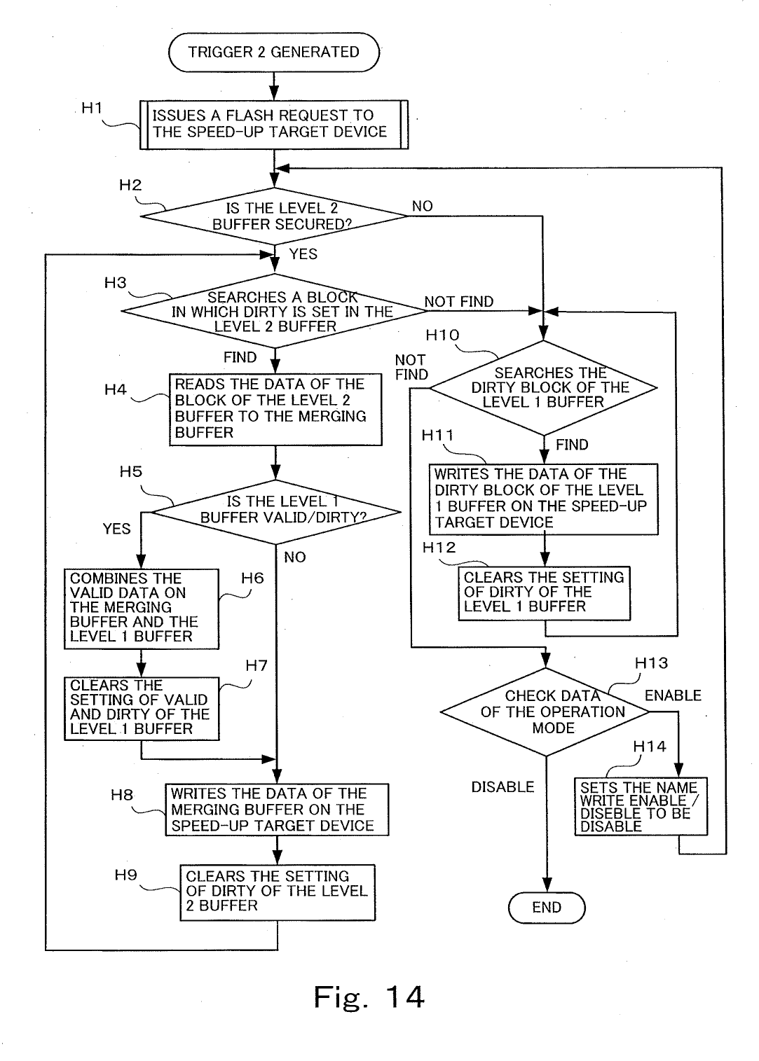

FIG. 11 is a flowchart illustrating an operation order when the information processing apparatus 100 makes a flash request. A flash request operation is executed in block H1 of FIG. 14 to be described below.

When the filter driver 14 receives a flash request from the service/user application 11, the filter driver 14 determines whether the device number and the flash address of the received flash request are the number and the address of a speed-up target (block E1). When the device and the address of the received flash request are not the device and the address of the speed-up target, the filter driver 14 executes a normal flash process (block E2) and notifies the OS 10 of a process end (block E3). When the filter driver determines that the device and the address of the received flash request are the device and the address of the speed-up target in block E1, the filter driver 14 determines whether the Level 2 Buffer 4B is ensured (block E4). When the Level 2 Buffer 4B is not ensured, the filter driver 14 does not execute any operation and notifies the OS 10 of the process end without performing any (block E3).

When the filter driver 14 determines that the Level 2 Buffer 4B is ensured in block E4, the filter driver 14 searches whether a block in which Dirty is set is present in the Level 1 Buffer 2A from the memory table (block E5). When the filter driver 14 does not find the Dirty block and the configuration management area (Shadow) 4A is ensured, the filter driver 14 writes configuration management information of the configuration management area 2B on the configuration management area (Shadow) 4A (block E6). Then, the filter driver 14 executes a flash process on the Level 2 Buffer 4B (block E7) and notifies the OS 10 of the process end (block E3). In the embodiment, since the configuration management area (Shadow) 4A is not ensured, block E6 is not executed and the process proceeds to block E7.

When the filter driver 14 finds the block in which Dirty is set in the Level 1 Buffer 2A in block E5, the filter driver 14 checks whether the Level 2 Buffer 4B is allocated, by referring to the column of the Level 2 address of the entry of the memory table indicating that the block in which Dirty is set in the found Level 1 Buffer 2A (block E8). When the Level 2 Buffer 4B is not allocated, the filter driver 14 allocates the Level 2 Buffer 4B and accordingly updates the memory table (block E9). The filter driver 14 writes data of the block in which Dirty of the Level 1 Buffer 2A is set on the Level 2 Buffer 4B (block E10). Next, the filter driver 14 clears the setting of Dirty of the Level 1 Buffer 2A (block Ell) and sets Dirty as the block allocated to the Level 2 Buffer 4B (block E12). The processes of block E5 to block E12 are repeated, until the setting of Dirty is cleared from the Level 1 Buffer 2A. When the setting of Dirty is cleared from Level 1 buffer 2A, the processes of block E5, block E6, block E7, and block E3 are executed and ends.

Here, a point is that the process ends by writing data only in the Level 2 Buffer 4B and the data is not yet written on the USB memory 5 which is a speed-up target device.

### (Initialization)

Various cache initialization conditions are assumed. An initialization condition by a user's operation will be described as a representative example. The service/user application 11 is connected to the user interface. As the user interface of the information processing apparatus 100, a switch or a button used to clear the contents of a cache is disposed for each target device. Pressing down the button is Trigger 1.

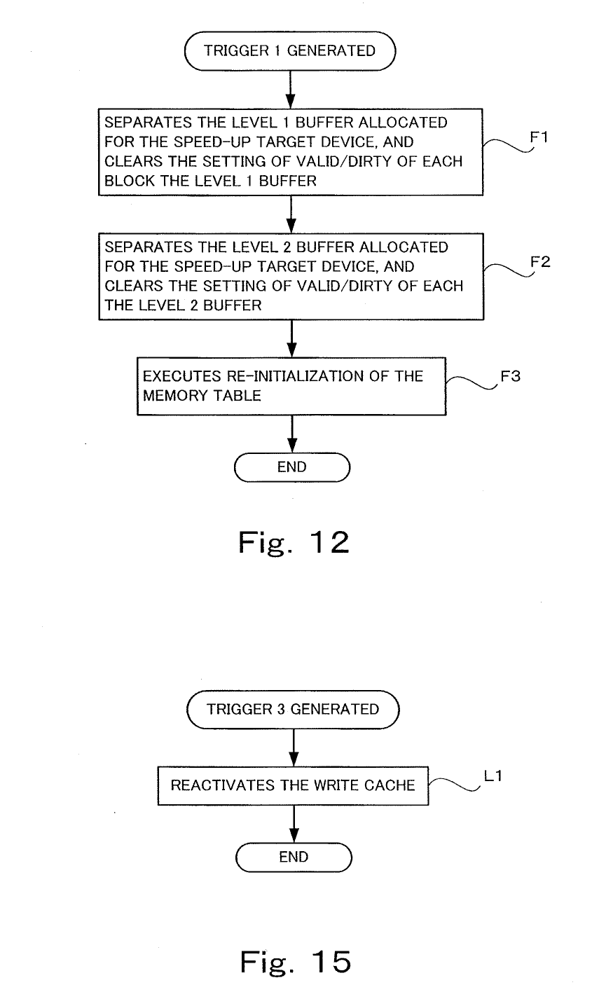

FIG. 12 is a flowchart illustrating an operation order when Trigger 1 of the information processing apparatus 100 is generated.

When Trigger 1 is generated, the service/user application 11 issues “Special Request 1” to the filter driver 14. When Trigger 1 is generated, the filter driver 14 searches the memory table, separates the Level 1 Buffer 2A by setting “Invalid” in the Level 1 Buffer 2A allocated for the cache operation of the speed-up target device (here, the USB memory 5), and simultaneously clears the setting of Valid/Dirty of each block of the Level 1 Buffer 2A (block F1). Subsequently, the filter driver 14 searches the memory table, separates the Level 2 Buffer 4B by setting “Invalid” in the Level 2 Buffer 4B allocated for the cache operation of the speed-up target device, and simultaneously clears the setting of Valid/Dirty of each block of the Level 2 Buffer 4B (block F2). The contents of Level 1 buffer 2A and the Level 2 Buffer 4B allocated for the cache operation are cleared (invalidated) through the execution of block F1 and block F2. Finally, the filter driver 14 causes valid blocks (=information regarding another speed-up target device) for other devices to remain and executes reinitialization of the memory table (block F3). The blocks F1 and F2 are invalidation processing.

Since all of the processes are executed within the memory 2, the original contents can be read instantaneously.

### (Eject)

In this embodiment, since the speed-up target device is the USB memory 5, the speed-up target device can be easily detached from the information processing apparatus 100. When the speed-up target device is detached, there are two methods of detaching the speed-up target device by giving a preliminary notice from the OS 10 and detaching the speed-up target device without a preliminary notice. In this embodiment, even in either method, the filter driver 14 itself detects the detachment phenomenon and executes an operation equivalent to the operation performed when Trigger 1 is generated.

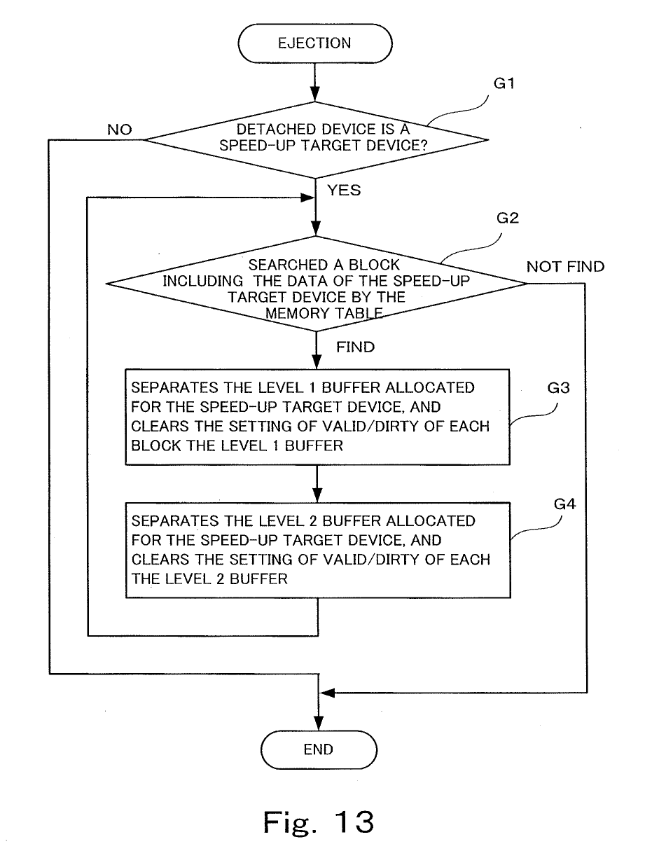

FIG. 13 is a flowchart illustrating an operation order of the information processing apparatus 100 at the time of ejection.

When ejection is detected, the filter driver 14 determines whether the detached device is a speed-up target device (hereinafter, an example will be made on the assumption that the USB memory 5 is detached) (block G1). When the detached device is not the USB memory 5, the filter driver 14 does not execute any operation. When the detached device is the USB memory 5, the filter driver 14 searches a block including the data of the USB memory 5 by the memory table (block G2). When the filter driver 14 does not find the data, the filter driver 14 does not execute any operation.

When the filter driver 14 finds the block including the data of the USB memory 5 in block G2, the filter driver 14 searches the memory table, separates the Level 1 Buffer 2A by setting “Invalid” in the Level 1 Buffer 2A allocated for the cache operation of the USB memory 5, and also clears the setting Dirty/Valid of each block of the Level 1 Buffer 2A (block G3). Likewise, the filter driver 14 separates the Level 2 Buffer 4B by setting “Invalid” in the Level 2 Buffer 4B allocated for the cache operation of the USB memory 5 and also clears the setting Dirty/Valid of each block of the Level 2 Buffer 4B (block G4). The filter driver 14 repeats the processes of block G2 to block G4, until the block including the data of the USB memory 5 is not present in the memory table. The contents of Level 1 buffer 2A and the Level 2 Buffer 4B allocated for the cache operation are deleted (invalidated) through the execution of block G3 and block G4.

Thus, by instantaneously erasing the data written to the USB memory 5, it is possible to prevent the data from leaking in advance.

### (Flash of Dirty Block)

Various write conditions in which data stored in the cache memory is written on a device are assumed. A write condition by a user's operation will be described as a representative example. The service/user application 11 is connected to the user interface. As the user interface of the information processing apparatus 100, a switch or a button used to permit the data stored in the cache memory to be written on a device is disposed. Pressing down the button is Trigger 2.

FIG. 14 is a flowchart illustrating an operation order when Trigger 2 of the information processing apparatus 100 is generated.

When Trigger 2 is generated, the service/user application 11 issues “Special Request 2” to the filter driver 14. When Trigger 2 is generated, the filter driver 14 issues a flash request illustrated in FIG. 11 to a speed-up target device (hereinafter, the USB memory 5 will be described as an example) for which data is permitted to be written (block H1). The filter driver 14 reduces the Dirty blocks of the Level 1 Buffer 2A through this process so that a part of the Level 1 Buffer 2A can be used as a merging Buffer 2D. The merging Buffer 2D is used when data stored in the Level 2 Buffer 4B is copied to the USB memory 5. When the Level 2 Buffer 4B is not ensured, any operation is not performed and the completion of the flash request is notified. In this case, since the Dirty block is present only in the Level 1 Buffer 2A, no problem particularly occurs.

When the completion of the flash request is notified through the process of FIG. 11, the filter driver 14 checks whether the Level 2 Buffer 4B is ensured, referring to the memory table (block H2). When the Level 2 Buffer 4B is ensured, the filter driver 14 searches a block in which Dirty is set in the Level 2 Buffer 4B, referring to the memory table (block H3). When the filter driver 14 finds the Dirty block in the Level 2 Buffer 4B, the filter driver 14 reads the data of the block of the Level 2 Buffer 4B to the merging Buffer 2D (block H4). Here, the merging Buffer 2D is provided inside the Level 1 Buffer 2A, but may be a dedicated intermediate buffer ensured separately from the Level 1 Buffer 2A.

In block H3, the filter driver 14 checks whether the block of level 1 Buffer 2A is allocated as the cache memory, referring to the column of the Level 1 address in the entry of the memory table in which the Dirty block of the Level 2 Buffer 4B is allocated can be found. When the block of the Level 1 Buffer 2A is allocated as the cache memory, the filter driver 14 determines whether a block state of the Level 1 Buffer 2A is Valid and Dirty, referring to the column of the block state in the entry (block H5). When the block state is Valid and Dirty, the filter driver 14 appropriately combines the valid data on the merging Buffer 2D and the Level 1 Buffer 2A to reconstruct the data on the merging Buffer 2D (block H6). Then, the filter driver 14 clears the setting of Valid and Dirty of the Level 1 Buffer 2A (block H7).

When the filter driver 14 determines that the block of the Level 1 Buffer 2A is not allocated as the cache memory in block H5 or the block state of the Level 1 Buffer 2A allocated as the cache memory is not Valid and Dirty and after the process of block H7 is completed, the filter driver 14 writes the data of the merging Buffer 2D on the USB memory 5 (block H8). Next, the filter driver 14 clears the setting of Dirty of the Level 2 Buffer 4B (block H9). The processes of block H3 to block H9 continue, until the Dirty block is not present in the Level 2 Buffer 4B.

When level 2 Buffer 4B is not ensured in block H2 and when the Dirty block is not present in the Level 2 Buffer 4B in block H3, the filter driver 14 searches the Dirty block of the Level 1 Buffer 2A from the memory table (block H10). When the filter driver 14 finds the Dirty block in the Level 1 Buffer 2A, the filter driver 14 writes the data of the Dirty block of the Level 1 Buffer 2A on the USB memory 5 (block H11) and clears the setting of the Dirty of the Level 1 Buffer 2A (block H12). The processes of block H10 to block H12 continue, until the Dirty block is not present in the Level 1 Buffer 2A.

When all of the Dirty blocks of the Level 1 Buffer 2A and the Level 2 Buffer 4B are not present in block H10, the filter driver 14 checks data of the operation mode (block H13). When a variable name of the data of the operation mode, Write Cache Enable/Disable is set to be Disable as the check result, the series of write processes is completed. On the other hand, when the variable name, Write Cache Enable/Disable is set to be Enable, there is a possibility that a Dirty block is newly generated during the series of processes. Therefore, the filter driver 14 sets the variable name of the data of the operation mode, Write Cache Enable/Disable, to be Disable (block H14) and repeats the processes from block H2.

The rewritten data are all written on the USB memory 5 (the speed-up target device permitted to execute the writing) through the process. In this state, since the write cache is stopped, the USB memory 5 can be ejected only at this timing with the latest data being maintained. When the USB memory 5 is not ejected and uncontrolled or rewriting is prohibited through a user's operation, the service/user application 11 issues “Special Request 3” to the filter driver 14. Issuing “Special Request 3” is Trigger 3. Then, the filter driver 14 reactivates the write cache (block I1 in FIG. 15).

### (Others)

The service/user application 11 periodically monitors a summary of the configuration management information output by the filter driver 14. When the Level 2 Buffer 4B is not allocated, the service/user application 11 prompts cache initialization/Dirty flash by notifying the user of a warning at the time at which an occupation ratio of the Dirty blocks of the Level 1 Buffer 2A exceeds a preset constant value. When the allocation of the Level 2 Buffer 4B is completed, the service/user application 11 prompts cache initialization/Dirty flash by notifying the user of a warning at the time at which an occupation ratio of the Dirty blocks of the Level 2 Buffer 4B exceeds a preset constant value.

In the information processing apparatus according to the embodiment, as described above, a risk of the data leakage can be reduced by controlling the writing of the data on the USB memory 5 (disturbing the update of the data) during the write cache operation.

### Second Embodiment

Next, a second embodiment will be described.

### (System Configuration)

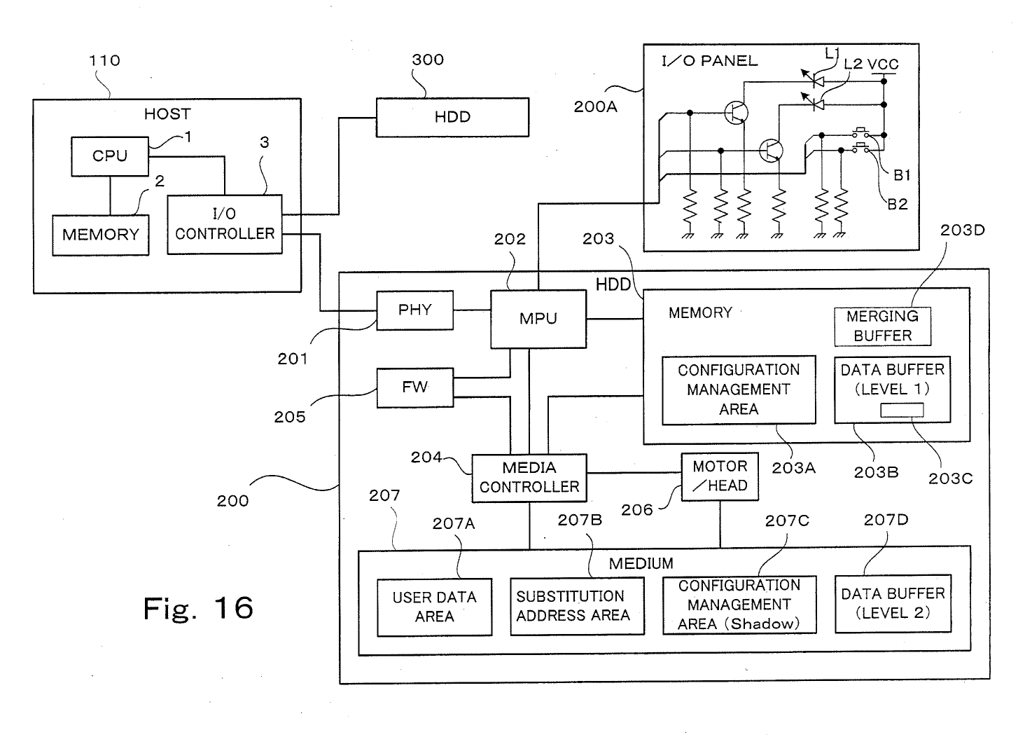

FIG. 16 is a diagram illustrating a computer system according to a second embodiment. An HDD 200 and an HDD 300 are auxiliary memory apparatuses. The HDD 200 and the HDD 300 are connected to a HOST 110 via an interface such as SATA/SAS/USB. An I/O controller 3 of the HOST 110 is connected to a main controller (hereinafter, referred to as an MPU) 202 of the HDD 200 via a PHY 201.

The MPU 202 interprets various requests from the HOST 110 and appropriately controls a memory 203 and a media controller 204. A control program stored in a firmware (FW) 205 is being executed in the MPU 202 and the media controller 204. Further, the media controller 204 executes position control of a motor/head 206, generation of a timing signal, reading control on a medium 207, modulation control of write data, error correction control, and the like in response to a request of the MPU 202.

In the medium 207, a user data area 207A is disposed as an area to which the HOST 110 can gain direct access. In a concealed area from the HOST 110, a substitution address area 207B is disposed in which substitution address information on a fault area or substitution address information of configuration management information used by the MPU 202 is stored. Further, the configuration management area (shadow) 207C and the Level 2 Buffer 207D described above are disposed in the concealed area. In an auxiliary memory apparatus having a general rotation medium, a pre-read cache or a write cache using the memory 203 is realized in the MPU 202 in order to conceal a mechanical movement time generated in the medium 207 or the motor/head 206. In the second embodiment, an additional logic is added to the write cache.

More specifically, a dedicated Level 1 Buffer (data buffer) 203B and a configuration management area 203A storing configuration management information are ensured inside the memory 203 of the HDD 200. Here, the user data area 207A of the medium 207 is a speed-up target device in a cache operation. A configuration management area (Shadow) 207C storing a copy of the configuration management information and a Level 2 Buffer (data buffer) 207D are prepared in the area of the medium 207 which is not usable directly from the HOST 110.

An I/O panel 200A is a user interface unique in the second embodiment. In the second embodiment, since a panel in which LEDs turn on and off during access includes an input switch, an instruction can be given to the MPU 202. An instruction from the I/O panel 200A can be substituted with a special request from the HOST 110. Here, two buttons are illustrated in the I/O panel 200A. One of the two buttons is an initialization button B1 and the other is a flash button B2. Two LEDs are illustrated. One of the two LEDs is an access lamp L1 and the other is a Dirty increase warning lamp L2.

The HDD 300 may execute the same operation as the HDD 200. In this case, the dedicated I/O panel 200A may also be connected to the HDD 300, as necessary.

The second embodiment is different from the first embodiment in that write data is maintained even when shutdown is performed and original data can be read instantaneously.

### (Code Configuration)

In the configuration illustrated in FIG. 16, all of the requests to the HDD 200 are monitored by the MPU 202. Therefore, the same logic of the write cache as that of the first embodiment is stored in the firmware (FW 205) executed by the MPU 202.

Here, the I/O panel 200A is connected to the HDD 200, but may be substituted with the same management application as the service/user application 11 operated inside the HOST 110. Even when the I/O panel 200A is not connected, a management application corresponding to the service/user application 11 activated inside the HOST 110 may be provided. Further, even when the same application as the service/user application 11 is not provided, an operation aimed in the embodiment can be realized.

### (Data Structure)

In the second embodiment, the cache operation is executed by the MPU 202. A firmware operating the MPU 202 is stored in the FW 205. An example of a data structure necessary to execute the cache operation will be described.

In the second embodiment, the configuration management information is stored in advance in the configuration management area (Shadow) 207C. FIG. 16 illustrates an example of the data structure configured to use the Level 2 Buffer 207D. A memory table and a device table which are the configuration management information will not be described in that the memory table and the device table are the same as those of the first embodiment except that the memory table and the device table do not have column of the device number illustrated in FIGS. 4A and 4B. An operation mode will not be described since the operation mode table is the same as that of the first embodiment. In the second embodiment, the device table is configured to have only two rows indicating a user data area (=Target) 207A and the Level 2 Buffer 207D. The memory table referred to/edited by the MPU 202 is included in the configuration management area 203A.

In general, the volatile memory 203 loses contents, when power is turned off. Therefore, the configuration management area (Shadow) 207C of the medium 207 is used as an area in which the configuration management information is maintained. The configuration management area (Shadow) 207C corresponds to the configuration management area (Shadow) 4A of the first embodiment.

### (Power On/Construction Order)

In the second embodiment, when power is turned on to the entire system including the auxiliary memory apparatus, the MPU 202 of the HDD 200 initializes a peripheral controller using the FW 205. At this time, the initialization is executed such that the media controller 204, the medium 207, and the motor/head 206 can be also accessed from the MPU 202.

At a time point at which the medium 207 can be accessed from the MPU 202 after initialization, the MPU 202 reads the substitution address information or the like on a fault area from the substitution address area 207B and stores the substitution address information in the memory 203.

The FW 205 stores the address or size of the configuration management area (Shadow) 207C, the size of the Level 1 Buffer 203B, the default contents of the data of an operation mode, and the like. The MPU 202 ensures the configuration management area 203A inside the memory 203, referring to the FW 205 (block corresponding to block A1 of FIG. 7). The MPU 202 reads the contents of the configuration management area (Shadow) 207C to the configuration management area 203A of the memory 203, as in the substitution address area 207B (block corresponding to block A2 of FIG. 7). The MPU 202 ensures the Level 1 Buffer 203B inside the memory 203, referring to the FW 205 (block corresponding to block A3 of FIG. 7). The MPU 202 reconstructs the Level 2 Buffer 207D, referring to the configuration management area 203A (block corresponding to block A4 of FIG. 7). The MPU 202 determines the memory table, the device table, data of the operation mode, and the like from the constructed information and starts the cache operation. Upon the completion of such processes, the HDD 200 can receive a request from the HOST 110.

Here, a point is that a cache learning state at the time of the previous activation can be recreated by reading the memory table from the configuration management area (Shadow) 207C. In the case of this installation example, setting of variable Level 2 Volatile/Nonvolatile of the data of the operation mode is Nonvolatile.

### (Shutdown Order)

In the second embodiment, it is necessary to store the contents of the memory table, since the configuration management area (Shadow) 207C is ensured.

In detection of shutdown, substitution detection of shutdown is executed using a Standby Immediate command in a case of an ATA command and using a STOP_UNIT command in a case of an SCSI command or the like. When the MPU 202 is notified of such a command, the MPU 202 checks the variable Level 2 Volatile/Nonvolatile of the data of the operation mode (the result is Nonvolatile) (block corresponding to block B1 of FIG. 8), executes the same process as the process performed at the time of receiving the flash request, and waits for the completion (block corresponding to block B2 of FIG. 8).

On the other hand, when the flash request is completed, the MPU 202 writes the contents of the configuration management area 203A on the configuration management area (Shadow) 207C (block corresponding to block B3 of FIG. 8). The MPU 202 requests the medium 207 to execute the flash process and a process corresponding to the received original command through the media controller 204.

### (Process at Each Request)

A read request and a write request will not be described, since the read request and the write request are the same as those of the first embodiment.

### (Flash Request)

The second embodiment is almost the same as the first embodiment, but is different in that a process corresponding to block E6 of FIG. 11 is inevitably executed, since the configuration management area (Shadow) 207C is ensured in the medium 207. That is, a process of writing the configuration management information such as the memory table stored in the configuration management area 203A on the configuration management area (Shadow) 207C is inevitably executed.

### (Initialization)

As in the first embodiment, various cache initialization conditions are assumed. As the most representative example of this embodiment, an example in which a physical button of the I/O panel 200A is used will be given. When the MPU 202 detects that an initialization button B1 of the I/O panel 200A is pressed down during the activation of the HDD 200, Trigger 1 is generated. The MPU 202 searches the memory table of the configuration management area 203A, separates the Level 1 Buffer 203B by setting “Invalid” in each block of the Level 1 Buffer 203B allocated for the cache operation of the speed-up target device, and simultaneously clears the setting of Valid/Dirty of each block of the Level 1 Buffer 203B (block corresponding to block F1 of FIG. 12). Subsequently, the MPU 202 likewise searches the memory table, separates the Level 2 Buffer 207D by setting “Invalid” in each block of the Level 2 Buffer 207D which is the speed-up target device, and simultaneously clears the setting of Valid/Dirty of each block of the Level 2 Buffer 207D (block corresponding to block F2 of FIG. 12). The contents of Level 1 buffer 203B and the Level 2 Buffer 207D are deleted (invalidated) through this process. Finally, the MPU 202 executes reinitialization of the memory table (block corresponding to block F3 of FIG. 12).

Since all of the processes are executed within the MPU 202 and the memory 203, the original contents can be read instantaneously. The configuration management area (Shadow) 207C is updated when the flash request or a shutdown request is detected.

An operation of updating the configuration management area (Shadow) 207C is executed after setup of the OS or the like is completed and at a timing when the user of the computer (the HOST 110) to which the HDD 200 is connected is switched, during a normal activation after flash of a Dirty block to be described below. Then, a new user cannot read the content changed by the immediately previous user, and thus a leakage accident can be prevented.

Precisely, the second embodiment is realized to achieve this aim, a method of issuing a special request is effective based on authentication at the time of activating the computer rather than the physical button of the I/O panel 200A.

### (Flash of Dirty Block)

Likewise in the above-described initialization, an example in which a physical button is used will be given. When the MPU 202 detects that a flash button B2 of the I/O panel 200A is pressed down during the activation of the HDD 200, Trigger 2 is generated.

When Trigger 2 is generated, the MPU 202 executes the same process as the process of receiving the flash request (block corresponding to block H1 of FIG. 14). The MPU 202 reduces the Dirty blocks of the Level 1 Buffer 203B through this process so that a part of the Level 1 Buffer 203B is used as an intermediate buffer 203C when data is copied from the Level 2 Buffer 207D to the user data area 207A.

When a process equivalent to the flash request described with reference to FIG. 11 in the first embodiment is completed, the MPU 202 searches the block in which Dirty is set in the Level 2 Buffer 207D from the memory table (block corresponding to block H3 of FIG. 14). When the MPU 202 finds the Dirty block in the Level 2 Buffer 207D, the MPU 202 reads data of the block of the Level 2 Buffer 207D to a merging Buffer 203D (block corresponding to block H4 of FIG. 14). Here, the merging Buffer 203D is provided inside the Level 1 Buffer 203B, but may be a dedicated intermediate buffer ensured separately from the Level 1 Buffer 203B.

The MPU 202 checks whether the block of level 1 Buffer 203B is allocated as the cache memory, referring to the column of the Level 1 address in the entry of the memory table in which the Dirty block of the Level 2 Buffer 207D is allocated. When the block of the Level 1 Buffer 203B is allocated as the cache memory, the MPU 202 determines whether a block state of the Level 1 Buffer 203B is Valid and Dirty, referring to the column of the block state in the entry (block corresponding to block H5 of FIG. 14). When the block state is Valid and Dirty, the MPU 202 appropriately combines the valid data on the merging Buffer 203D and the Level 1 Buffer 203B to reconstruct the data on the merging Buffer 203D (block corresponding to block H6 of FIG. 14). Then, the MPU 202 clears the setting of Dirty of the Level 1 Buffer 203B (block corresponding to block H7 of FIG. 14).

When the MPU 202 determines that the block of the Level 1 Buffer 203B is not allocated as the cache memory or the block state of the Level 1 Buffer 203B allocated as the cache memory is not Valid and Dirty and after the process corresponding to block H7 of FIG. 14 is completed, the MPU 202 writes the data of the merging Buffer 203D on the user data area 207A (block corresponding to block H8 of FIG. 14). Next, the MPU 202 clears the setting of Dirty of the Level 2 Buffer 207D (block corresponding to block H9 of FIG. 14). The processes (corresponding to block H3 to block H9 of FIG. 14) continue, until the Dirty block is not present in the Level 2 Buffer 207D.

When the Dirty block is not present in the Level 2 Buffer 207D, the MPU 202 searches the Dirty block of the Level 1 Buffer 203B from the memory table (block corresponding to block H10 of FIG. 14). When the MPU 202 finds the Dirty block in the Level 1 Buffer 203B, the MPU 202 writes the data of the Dirty block of the Level 1 Buffer 203B on the user data area 207A (block corresponding to block H11 of FIG. 14). Then, the MPU 202 clears the setting of Dirty of the Level 1 Buffer 21 (block corresponding to block H12 of FIG. 14). The processes (corresponding to block H10 to block H12 of FIG. 14) continue, until the Dirty block is not present in the Level 1 Buffer 203B.

When all of the Dirty blocks of the Level 1 Buffer 203B and the Level 2 Buffer 207D are not present, the MPU 202 checks data of the operation mode. When a variable, Write Cache Enable/Disable, is set to be Disable as the check result, the series of write processes is completed (corresponding to the positive determination of block H13 of FIG. 14). On the other hand, when the variable, Write Cache Enable/Disable is set to be Enable, there is a possibility that a Dirty block is newly generated during the series of processes. Therefore, the MPU 202 sets the variable, Write Cache Enable/Disable of the data of the operation mode, to be Disable (block corresponding to block H14 of FIG. 14). Thereafter, the MPU 202 returns the process to the process (corresponding to block H3 of FIG. 14) of searching the block in which Dirty is set in the Level 2 Buffer 207D from the memory table and repeats the subsequent processes.

The rewritten data are all written on the user data area 207A through the process. In this state, since the write cache is stopped, a system updating process such as a process of updating the OS is performed at this timing. When the updating process or the like is completed, the flash button B2 of the I/O panel 200A is pressed down again. Then, Trigger 3 is generated and the MPU 202 resumes the write cache (block corresponding to block I1 of FIG. 15). It is desirable that the flash button B2 is not accessed by users other than an administrator of the computer (the HOST 110).

### (Others)

The MPU 202 periodically monitors the configuration management information. When an occupation ratio of the Dirty blocks of the Level 2 Buffer 2070 exceeds a preset constant value, the MPU 202 prompts the flash of the cache initialization/flash of the Dirty block by giving a warning notification via an LED of the I/O panel 200A. The monitoring can be substituted with a monitoring application such as the service/user application 11.

In the memory apparatus according to the second embodiment, as described above, as in the information processing apparatus according to the first embodiment, a risk of the data leakage can be reduced by controlling the writing of the data on the medium (disturbing the update of the medium) during the write cache operation. Therefore, the system state can be maintained. Accordingly, for example, installation of unauthorized software or the like can be cancelled later.

Since the operation control process of each embodiment can be realized by software (program), the advantages of each embodiment can easily be realized by installing the software in a general computer through a computer-readable memory medium storing the software.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first memory apparatus;
a second memory apparatus; and
a caching unit that stores write data to be written on the second memory apparatus in a cache area ensured on the first memory apparatus,
wherein, when a first event occurs, the caching unit initializes a management information table so as to do restores the second memory apparatus to the state before the writing of the write data, the management information table in which an address of the cache area in which the write data is stored is associated with an address of the second memory apparatus in which the write data is to be stored.

2. The information processing apparatus according to claim 1, wherein
the second memory apparatus is a removable device which is able to be ejected, and
the first event is a request for detaching the second memory apparatus.

3. The information processing apparatus according to claim 1, wherein, when a second even occurs, the cashing unit writes the write data stored in the cache area on the second memory apparatus based on the management information table and updates the second memory apparatus to a latest state.

4. The information processing apparatus according to claim 3, wherein
the first memory apparatus is a nonvolatile memory apparatus, and
even when reactivation is executed without occurrence of the second event, the caching unit causes the second memory apparatus to be usable in a state in which data written at a time of previous activation is valid by managing the management information table on the first memory apparatus.

5. The information processing apparatus according to claim 3, wherein
the first memory apparatus is a volatile memory apparatus, and
even in reactivation without occurrence of the second event, the caching unit initializes the management information table for restores the second memory apparatus to state before the writing of the write data, by managing the management information table on the first memory apparatus.

6. The information processing apparatus according to claim 1, wherein the caching unit gives a warning indicating that a vacant capacity of a buffer area is insufficient, when the vacant capacity of the buffer area in which the write data is not stored in the cache area is less than a capacity determined as a threshold value.

7. The information processing apparatus according to claim 1, wherein the caching unit executes error end of the writing of the data on the second memory apparatus, when there is no capacity of a buffer area in which the write data is not stored in the cache area.

8. A memory apparatus comprising:
a first memory medium;
a second memory medium;
a media controller that executes writing data on the second memory medium and reading data from the second memory medium, using the first memory medium as a cache of the second memory medium; and
a processor that controls the media controller such that the media controller initializes data cached in the first memory medium when a first signal is input, and controls the media controller such that the media controller writes write data cached in the first memory medium on the second memory medium when a second signal is input.

9. The memory apparatus according to claim 8, wherein
the first memory medium is a nonvolatile memory medium, and
even when reactivation is executed without input of the second signal, the processor causes the write data cached in the first memory medium to be usable at a time of previous activation by managing a management information table in a specific area of the second memory medium, the management information table in which an address of the write data cached in the first memory medium is associated with an address of the second memory medium.

10. The memory apparatus according to claim 8, wherein
the first memory medium is a volatile memory medium, and
when reactivation is executed without input of the second signal, the processor restores the first memory medium to state before the writing of the write data.

11. The memory apparatus according to claim 8, wherein, the processor gives a warning indicating that a vacant capacity of a buffer area is insufficient, when the vacant capacity of the buffer area in which the write data ensured on the first memory medium is less than determined as a threshold value.

12. The memory apparatus according to claim 8, wherein, the media controller executes error end of the writing of the data on the first memory medium, when there is no capacity of a buffer area in which the write data ensured on the first memory medium.

13. A data management method for an information processing apparatus having a first memory apparatus and a second memory apparatus, the method comprising:
storing write data to be written on the second memory apparatus in a cache area ensured on the first memory apparatus;
initializing a management information table for restores the second memory apparatus to the state before the writing of the write data, the management information table in which an address of the cache area in which the write data is stored is associated with an address of the second memory apparatus in which the write data is to be stored, when a first event occurs.

14. The data management method according to claim 13, further comprising:
writing the write data stored in the cache area on the second memory apparatus based on the management information table, updating the second memory apparatus to a latest state, when a second event occurs.

15. The data management method according to claim 13, further comprising:
giving a warning indicating that a vacant capacity of a buffer area is insufficient, when the vacant capacity of the buffer area in which the write data is not stored in the cache area is less than a capacity determined as a threshold value.

16. The data management method according to claim 13, further comprising:
executing error end of the writing of the data on the second memory apparatus, when there is no capacity of a vacant buffer area in which the write data is not stored in the cache area.

17. An information processing apparatus comprising:
a main memory that includes a cache area;
a removable disk that is treated as a speed-up target device;
a caching unit that stores write data to be written on the removable disk in the cache area; and
a management information table in which an address of the cache area in which the write data is stored is associated with an address of the removable disk in which the write data is to be stored,
wherein the caching unit stores the write data in a block of the cache area determined based on the management information table in response to a request to write the write data on the removable disk and also marks data writing in a block corresponding to the management information table, and
the caching unit writes the write data stored in the cache area onto the removable disk and also initializes the block corresponding to the management information table, when a write event on the removable disk occurs.

18. An information processing apparatus comprising:
a main memory that includes a first cache area;
a removable disk that is treated as a speed-up target device;
a system HDD that includes a second cache area;
a caching unit that stores write data to be written on the removable disk in the first cache area or/and the second cache area; and
a management information table which is stored at least in the main memory and in which an address of the first cache area or/and the second cache area in which the write data is stored is associated with an address of the removable disk in which the write data is to be stored,
wherein the caching unit stores the write data in a block of the first cache area or/and the second cache area determined based on the management information table in response to a request to write the write data on the removable disk and also marks data writing in a block corresponding to the management information table, and
the caching unit writes the write data stored in the first cache area or/and the second cache area on the removable disk and also initializes the block corresponding to the management information table, when a write event on the removable disk occurs.

19. An HDD apparatus connected to a host computer, the HDD apparatus comprising:
a memory that includes a cache area;
an HDD medium that includes a data area of a speed-up target;
a media controller that writes data on the HDD medium and reads data from the HDD medium;
a management information table in which an address of the cache area in which write data is stored is associated with an address of the data area of the HDD medium in which the write data is to be stored; and
a processor that marks a corresponding block of the management information table to separate the cache area and also controls the media controller such that the media controller initializes the data cached in the cache area, when a first signal is input, and that controls the media controller such that the media controller searches the write data cached in the cache area from the management information table and writes the write data on the data area, when a second signal is input.
